(19) United States
(12) Patent Application Publication
(10) Pub. No.: US 2022/0180649 A1
(43) Pub. Date: Jun. 9, 2022

(54) Multiple Camera Jersey Number Recognition

(71) Applicant: Intel Corporation, Santa Clara, CA (US)

(72) Inventors: Qiang Li, Beijing (CN); Wenlong Li, Beijing (CN); Chen Ling, Beijing (CN); Hang Zheng, Beijing (CN)

(21) Appl. No.: 17/438,348

(22) PCT Filed: Jul. 31, 2019
(86) PCT No.: PCT/CN2019/098518

§ 371 Date: Sep. 10, 2021

(51) Int. Cl. G06V 20/62; G06T 7/73; G06V 10/764; G06V 10/22; G06V 10/44; G06V 20/70; G06V 10/82; G06V 40/10

(52) U.S. Cl. CPC G06V 20/63; G06T 7/73; G06V 10/764; G06V 10/225; G06V 10/44; G06T 2207/30221; G06V 10/82; G06V 40/103; G06T 2207/30196; G06T 2207/20084; G06V 20/70

(57) ABSTRACT

A method is described herein. The method includes the designation of a player as a profile player or a non-profile player in each camera view. In response to the player being a non-profile player, the method includes extracting features from the detected player within the bounding box and classifying the features according to a label. In response to the player being a non-profile player, the method also includes selecting a label with a highest number of votes according to a voting policy as a final label.

### BACKGROUND

Multiple cameras are used to capture activity in a scene. Subsequent processing of the captured images enables end users to view the scene and move throughout the scene in over a full 360-degree range of motion. For example, multiple cameras may be used to capture a sports game and end users can move throughout the field of play freely. The end user may also view the game from a virtual camera.

### BRIEF DESCRIPTION OF THE DRAWINGS

FIG. 1 is a process flow diagram of a method 100 that enables multiple camera jersey recognition;

FIG. 2 is an illustration of a field of play in a stadium;

FIG. 3 is an illustration of players;

FIG. 4 is a plurality of cropped images captured by a camera system;

FIG. 5 is a single camera view;

FIG. 6 is an illustration of a process for padding the bounding box for each player;

FIG. 7, FIG. 8A, and FIG. 8B illustrate a feature extraction network according to the present techniques;

FIG. 9 is an illustration of feature extraction;

FIG. 10 is an illustration of feature/extraction matching results after hard non-maximum suppression (NMS);

FIG. 11 is an illustration of jersey number recognition results with two outputs;

FIG. 12 is a process flow diagram illustrating a method for cumulative voting;

FIG. 13 is a process flow diagram of a method that enables multiple camera jersey recognition;

FIG. 14 is a block diagram is shown illustrating an immersive media experience; and

FIG. 15 is a block diagram showing computer readable media that stores code for immersive media experience.

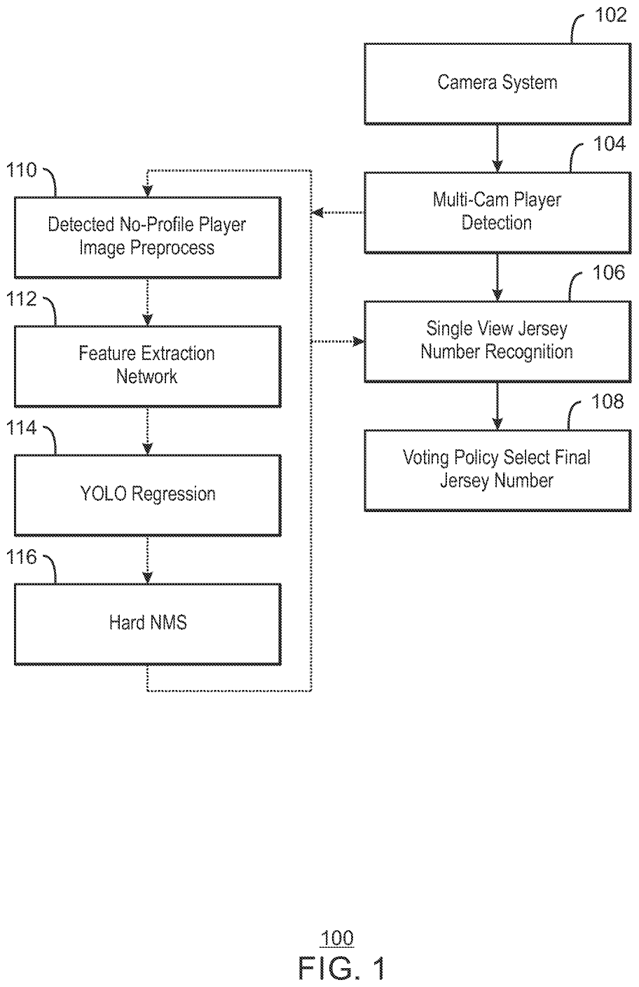

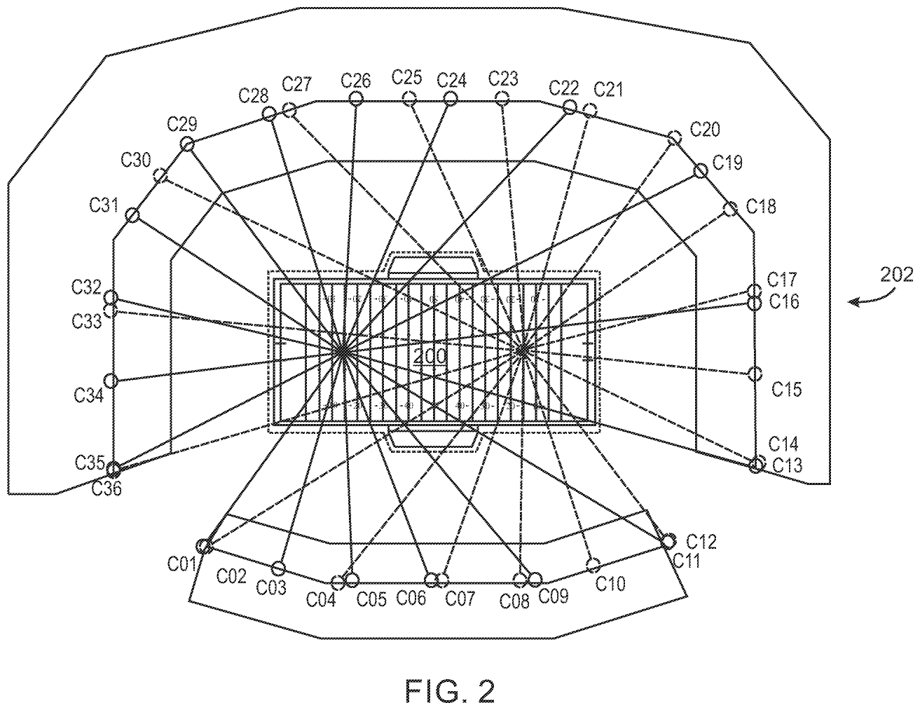

The same numbers are used throughout the disclosure and the figures to reference like components and features. Numbers in the 100 series refer to features originally found in FIG. 1; numbers in the 200 series refer to features originally found in FIG. 2B; and so on.

### DESCRIPTION OF THE EMBODIMENTS

Sporting events and other competitions are often broadcast for the entertainment of end users. These games may be rendered in a variety of formats. For example, a game can be rendered as a two-dimensional video or a three-dimensional video. The games may be captured using one or more high-resolution cameras positioned around an entire field of play. The plurality of cameras may capture an entire three-dimensional volumetric space, including the field of play. In embodiments, the camera system may include multiple super high-resolution cameras for volumetric capture. The end users can view the action of the game and move through the captured volume freely by being present with a sequence of images representing the three-dimensional volumetric space. Additionally, an end user can view the game from a virtual camera that follows the action within the field by following the ball or a specific player in the three-dimensional volumetric space.

The present techniques enable jersey number recognition in a multiple camera system. In embodiments, providing an immersive media experience for an end user may be based, in part, on identifying the jersey number, team identity, and player location for each player in real time. The stable and highly accurate jersey number recognition system according to the present techniques can extract small jersey numbers (or other indicators/identifiers) on the body of a player even during constant movement by the player. For example, in a video at a 4K resolution, player jersey numbers are a very small portion of each captured image frame. Furthermore, a player's body posture also changes drastically during the video, which causes deformation of the jersey number image or the indicator image. This deformation negatively impacts jersey number recognition accuracy. Second, when the player is oriented in a semi-profile position and is wearing a double-digit jersey number, it is very likely that only one digit of the jersey number is visible. This causes jersey number recognition results that are unreliable and error-prone. Often, conventional techniques recognize the player's jersey number only when the player's jersey number is clearly visible, which is not generally applicable in single camera system. Therefore, the present techniques enable a multiple camera jersey number recognition solution to address all these challenges. In this manner, an immersive media experience is provided to end users in real-time.

As used herein, a game may refer to a form of play according to a set of rules. The game may be played for recreation, entertainment, or achievement. A competitive game may be referred to as a sport, sporting event, or competition. Accordingly, a sport may also be a form of competitive physical activity. The game may have an audience of spectators that observe the game. The spectators may be referred to as end-users when the spectators observe the game via an electronic device, as opposed to viewing the game live and in person. The game may be competitive in nature and organized such that opposing individuals or teams compete to win. A win refers to a first individual or first team being recognized as triumphing over other individuals or teams. A win may also result in an individual or team meeting or securing an achievement. Often, the game is played on a field, court, within an arena, or some other area designated for game play. The area designated for game play typically includes markings, goal posts, nets, and the like to facilitate game play.

A game may be organized as any number of individuals configured in an opposing fashion and competing to win. A team sport is a game where a plurality of individuals is organized into opposing teams. The individuals may be generally referred to as players. The opposing teams may compete to win. Often, the competition includes each player making a strategic movement to successfully overcome one or more players to meet a game objective. An example of a team sport is football.

Generally, football describes a family of games where a ball is kicked at various times to ultimately score a goal. Football may include, for example, association football, gridiron football, rugby football. American football may be a variation of gridiron football. In embodiments, the American football described herein may be as played according to the rules and regulations of the National Football League (NFL). While American football is described, the present techniques may apply to any event where an individual makes strategic movements within a defined space. In embodiments, a strategic movement may be referred to as a trajectory. An end user can be immersed in a rendering of the event based on this trajectory according to the techniques described herein. In particular, the present techniques enable the identification of all the players in the field of play by deriving the corresponding jersey and team information. Again, for ease of description, the present techniques are described using an American football game as an example. However, any game, sport, sporting event, or competition may be used according to the present techniques. For example, the game types may include major sports such as basketball, baseball, hockey, lacrosse, and the like.

FIG. 1 is a process flow diagram of a method 100 that enables multiple camera jersey recognition. The present techniques enable jersey number recognition by using several camera views, each from a different camera, as input. Conventional techniques are limited to recognizing jersey numbers only when the camera captures the player positioned at an orientation where a plane on which the jersey number or other identifier worn by the player is parallel with an image plane of the camera. For example, this may occur when the player is substantially facing the camera. In this example, the plane of the lettering across the front-side of the player is readily visible in an image captured by the player. However, during the course of a game, the player may move frequently and the jersey number or identifier may face the camera for only a few seconds. Second, conventional techniques they do not provide a sustainable solution to handle the differences in players' body posture, image deformation, player occlusion, etc.

At block 102, a camera system 102 is to capture a field of play. In embodiments, the camera system may include one or more physical cameras with a 5120×3072 resolution, configured throughout a stadium to capture the field of play. For example, the number of cameras in the camera system may be thirty-eight. Although particular camera resolutions are described, any camera resolution may be used according to the present techniques. A subset of cameras may be selected, such as eighteen cameras from among the thirty-eight cameras, to cover the entire field of play and ensure that each pixel in the field of play is captured by at least three cameras. The camera system 102 captures a real-time video stream from a plurality of cameras. The plurality of cameras may capture the field of play at 30 frames per second (fps). The subset of cameras selected may be different in different scenarios. For example, depending on the structure surrounding the field of play, each location may be captured by at least three cameras using a smaller or larger subset of cameras. Thus, in embodiments the number of cameras used in the camera system is calculated be determining the number of cameras needed to capture each point within the field of play by at least three cameras.

At block 104, multiple camera player detection is executed to determine isolated bounding boxes surrounding each player in each camera view captured by the camera system 202. Multiple camera player detection module detects and associates a player from multiple cameras and outputs player orientation labels. In embodiments, bounding boxes of a player in each camera view captured by a camera system may be determined. In particular, player detection is performed for each camera view. A person detection algorithm based on a you only look once (YOLO) approach in a multiple camera framework may be executed for each frame captured by a camera. The person detection algorithm is executed to detect all the players in field of play.

The bounding boxes derived for each player from each camera of the camera system may be used as input for single view jersey number recognition. In particular, a single view jersey number recognition uses a pre-designed template to crop a player detection image, followed by a lightweight but powerful feature extraction and classification network. Accordingly, at block 106, single use jersey number recognition is executed. The single use jersey number recognition as described herein includes pre-processing, feature extraction, feature matching, and hard non-maximum suppression. As illustrated at block 110, a single view jersey number recognition process takes as input the detected profile player images as defined by a bounding box. At block 112, features are extracted from the detected non-profile player images. At block 114, a you only look once (YOLO) regression is applied to the extracted features. Finally, at block 116, a hard non-maximum suppression (NMS) algorithm is applied to the features. In particular, a hard NMS algorithm is executed within single cam jersey number recognition to handle double digit number failure cases. The single view jersey number recognition technique at block 106 may take as input detected non-profile player images from block 104 and extracts jersey numbers from each image.

At block 108, a voting policy is implemented to selected a final jersey number. As described herein, the voting policy is implemented to improve the multiple camera jersey number recognition stability, and generates the final jersey number from all single cam jersey number recognition results. As illustrated by FIG. 1, jersey number recognition is an end to end number detection and recognition task that incorporates the importance of number location.

Specifically, orientation detection is incorporated in the jersey recognition, which incorporates the importance of jersey number location. An orientation attribute is defined that can be used as input for a single camera player recognition process. The present techniques also include a light-weight convolutional neural network (CNN) to efficiently leverage both the high level and low-level semantic features extracted from an image of a player. These features include, but are not limited to, words, symbols, phrases, and the like. A hard-NMS may be executed to eliminate the single digit and double digit that can occur according to player orientation. A multiple camera voting policy is used to fuse and infer the final jersey number result with high accuracy. Thus, the present techniques enable real-time, stable, and highly accurate player jersey number recognition. The player jersey recognition may be further used to create engaging live broadcast and analysis of a game in real-time.

FIG. 2 is an illustration of a field of play 200 in a stadium 202. Generally, the “field of play” may be referred to as a field. In the as illustrated, the stadium 202 completely surrounds the field of play 200. During game play, players may make movements on and off the field of play. Moreover, while on the field of play, players may move in many different directions. To capture the game play described above, a plurality of cameras may be located throughout the stadium 202. In the example of FIG. 2, the cameras C01-C36 are positioned at various points around the field of play. Multiple synchronized cameras installed in the stadium 202 are used to create a multiple camera system 102 as described with respect to the example of FIG. 1. In embodiments, the camera system captures video of the game. Player detection is executed to determine the player locations in every single view. Player detection may also identify player bounding boxes within each camera view and associates every player location from each single camera view to determine the position of each player on the field of play. In embodiments, associating every player location from each single camera view refers to finding correspondences between a detected player for each camera view of the camera system. The position may be a three-dimensional location of the player on a ground plane of the captured 3D volume. As used herein, the ground plane is a generally flat virtual plane that indicates the ground of the captured 3D volume. Points along the ground plane may be used to estimate a homography matrix between the image plane and ground.

As illustrated in the example of FIG. 2, the field of play 200 may be an American football field. An American football field is rectangular in shape with a length of 220 yards and a width of 53⅓ yards. Lines along the long edge of the field of play 200 may be referred to as sidelines. Lines along the short edge of the field of play 200 may be referred to as end lines. The goal lines are located 10 yards from the end lines, respectively. The yard lines are marked every 5 yards from one goal line to the other goal line. Hash marks may be short parallel lines that occur in one-yard increments between each yard line. Goalposts and may be located at the center of each end line and. Additionally, the field of play may be adorned with logos and other emblems that represent the team that owns the field.

The field of play 200 includes end zones and at each end of the field of play. During play, a first team is designated as the offense, and a second team is designated as the defense. The ball used during play is an oval or prolate spheroid. The offense controls the ball, while the defense is without control of the ball. The offense attempts to advance the ball down the length of the rectangular field by running or passing the ball while the defense simultaneously attempts to prevent the offense from advancing the ball down the length of the field. The defense may also attempt to take control of the ball. Generally, to begin a round of play opposing teams line up in a particular format. A round of play may be referred to as a down. During each down, the offense is given an opportunity to execute a play to advance down the field. To begin a play, the offense and defense line up along a line of scrimmage according to various schemes. For example, an offense will line up in a formation in an attempt to overcome the defense and advance the ball toward the goal line. If the offense can advance the ball past the goal line and into the end zone, the offense will score a touchdown and is awarded points. The offense is also given a try to obtain points after the touchdown.

An American football game is about four hours in duration including all breaks where no gameplay occurs. In some cases, about half of the four hours includes active gameplay, while the other half is some sort of break. As used herein, a break may refer to team timeouts, official timeouts, commercial timeouts, halftime, time during transition after a turnover, and the like. The game may begin with a kickoff, where the kicking team kicks the ball to the receiving team. During the kickoff, the team who will be considered the offense after the kickoff is the receiving team, while the kicking team is typically considered the defense. After the kickoff, the offense must advance the ball at least ten yards downfield in four downs, or otherwise the offense turns the football over to the defense. If the offense succeeds in advancing the ball ten yards or more, a new set of four downs is given to the offense to use in advancing the ball another ten yards. Generally, points are given to the team that advances the ball into the opposing team's end zone or kicks the ball through the goal posts of the opposing team. The team with the most points at the end of a game wins. There are also a number of special plays that may be executed during a down, including but not limited to, punts, field goals, and extra point attempts.

Each team may include a plurality of players. The players that belong to a same team generally where the same colors for uniforms during game play. To distinguish players of the same team, each player may have an identifier that is unique among players of the same team. For example, in American football an identifier is a number worn on the uniform of the player. The number often is found on a jersey worn by the player, and is typically is found on the front and back of the jersey. Accordingly, the identifier may be referred to as a jersey number. In some cases, the identifier is also found on the helmet, shoulders, pants, or shoes worn by the player.

Multiple calibrated cameras may be deployed in the stadium 202 to capture high-resolution images of the field 200. The images may be processed via segmentation and three-dimensional (3D) reconstruction to create a 3D volumetric model. In embodiments, subset of cameras from a set of all available cameras may be selected for image capture, such as eighteen cameras from among the thirty-six cameras as illustrated in FIG. 2. The eighteen cameras may be selected so that entire field of play 200 is captured by at least three cameras. The camera system of the eighteen cameras may capture a real-time video stream via the plurality of cameras. In embodiments, the plurality of cameras may capture the field of play at 30 frames per second (fps).

By capturing the game on a field of play with multiple cameras, an immersive viewing experience may be generated for an end user. In embodiments, based on the player trajectory, an immersive media experience may be provided. In some cases, the immersive media experience is provided in real-time. Alternatively, the immersive media experience may be a replay of a previously captured game. In the immersive media experience, an end user can follow the ball and players with a full 360-degree freedom of movement within the field of play. In embodiments, the present techniques enable a virtual camera that follows the player to generate volumetric video.

In embodiments, the present techniques may enable tracking of all players or individuals during a game or an event. The tracking of a player may be based, at least in part, on identifying the player across multiple camera views, wherein each camera of the camera system corresponds to a camera view. The present techniques enable an identification of a player in each camera view based on a number or other identifier worn on the body of the player. Moreover, the present techniques enable an optical solution to track each player, including when players are substituted between downs, according to jersey recognition via a single camera.

The diagram of FIG. 2 is not intended to indicate that the example field 200 is to include all of the cameras or field shown in FIG. 2. Rather, the example camera system can be implemented using fewer or additional cameras not illustrated in FIG. 2. Further, the example field can be a different court, area, or other playing area of a different shape, size, or type not illustrated in FIG. 2.

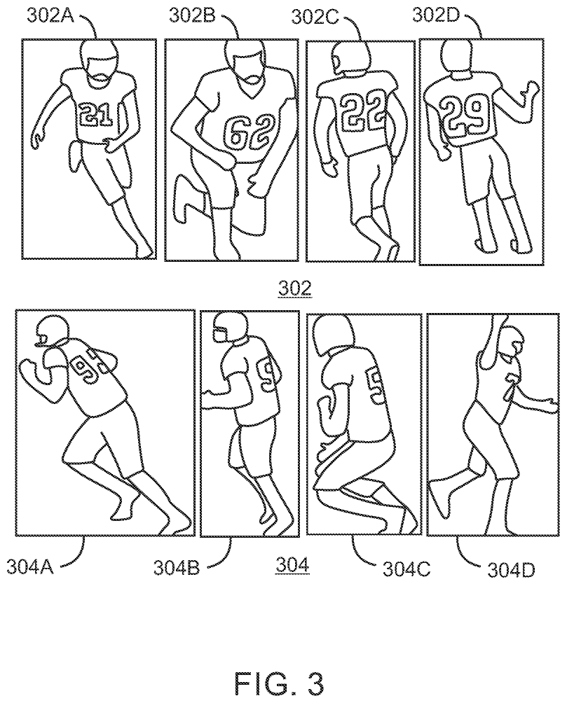

FIG. 3 is an illustration of players 300. The players 300 may play a game on the field 200 and be captured by camera systems such as the cameras C01-C38 illustrated in FIG. 2. As illustrated, the players 300 include non-profile players 302, and profile players 304. As described above, players move frequently in a strategic fashion throughout the field of play. As a result, the identifier worn on the body of the player may be entirely or partially obscured during game play, thereby reducing jersey number visibility. As a result, the player may not be easily identified according to the worn identifier as a result of the identifier being obscured or otherwise blocked in a camera view.

In embodiments, if the player's body orientation is nearly parallel to the image plane of the camera view, the jersey number is likely clearly visible. When the identifier or jersey number is clearly visible, the player may be classified as a non-profile player (NP). Otherwise, the player is classified as a profile player (P). In embodiments, the profile player may be oriented such that a substantially side view of the player is captured in a particular camera view. In this side view, the identifier worn by the player is not visible. By contrast, by a non-profile player is not oriented such that a side view of the player is captured. In the capture of the non-profile player, the identifier worn by the player is visible.

FIG. 3 illustrates a non-profile player 302A, non-profile player 302B, non-profile player 302C, and non-profile player 302D. As illustrated, the jersey number of each non-profile player 302 is substantially visible. As used herein, substantially visible refers to a view of the identifier where in the visible portion of the identifier can be used to derive the entire identifier. FIG. 3 further illustrates a profile player 304A, profile player 304B, profile player 304C, and profile player 304D. As illustrated, the jersey number of each profile player 304 is not substantially visible. For each non-profile player 304, the jersey number cannot be derived from the camera view, as the jersey number is not substantially visible.

In embodiments, an identifier may be considered visible in a camera view when a plane of the identifier is substantially parallel with the image plane of the camera view. The plane of the identifier refers to the plane where most of the identifier is visible when worn on the uniform of the player. As used herein, the plane of the identifier is substantially parallel with the image plane of the camera view when an angle between the plane of the identifier and the image plane is less than approximately sixty-seven degrees. Note that in the example of a football player, the jersey number may be distorted or otherwise not smooth as applied to the jersey worn on the body of the player, even when the plane of the identifier (jersey number) is substantially parallel when the image plane of the camera. This is due to padding and body shape causing some stretching, deforming, or folding of the number as it is worn on the player. However, the present techniques enable the determination of the identifier even when it is stretched, deformed, or otherwise distorted.

An identifier should be substantially visible in a camera view in order to recognize the identifier. As described above, the identifier is substantially visible for non-profile players and the identifier is not substantially visible for profile players. Accordingly, images of a player where the orientation of that player is a non-profile player orientation are used for jersey number recognition. Images where a player is oriented as a profile player in a camera view are not used for jersey number recognition. In embodiments, the players are detected according to player detection techniques and classified as a non-profile player or a profile player for each frame of each camera view based on the orientation of the player. The player's orientation changes from frame to frame in each camera view. The detected player in each frame of each camera view may be used for single camera jersey recognition. As described below, the present techniques can ensure detection of double-digit jersey numbers as two digits as opposed to a single digit. Additionally, the present techniques avoid additional computational cost by not attempting single camera jersey recognition on profile players. Conventional techniques may misrepresent double digit jersey numbers as single digit jersey number due to occlusion. Further, conventional techniques incur additional computational costs when processing all detected players.

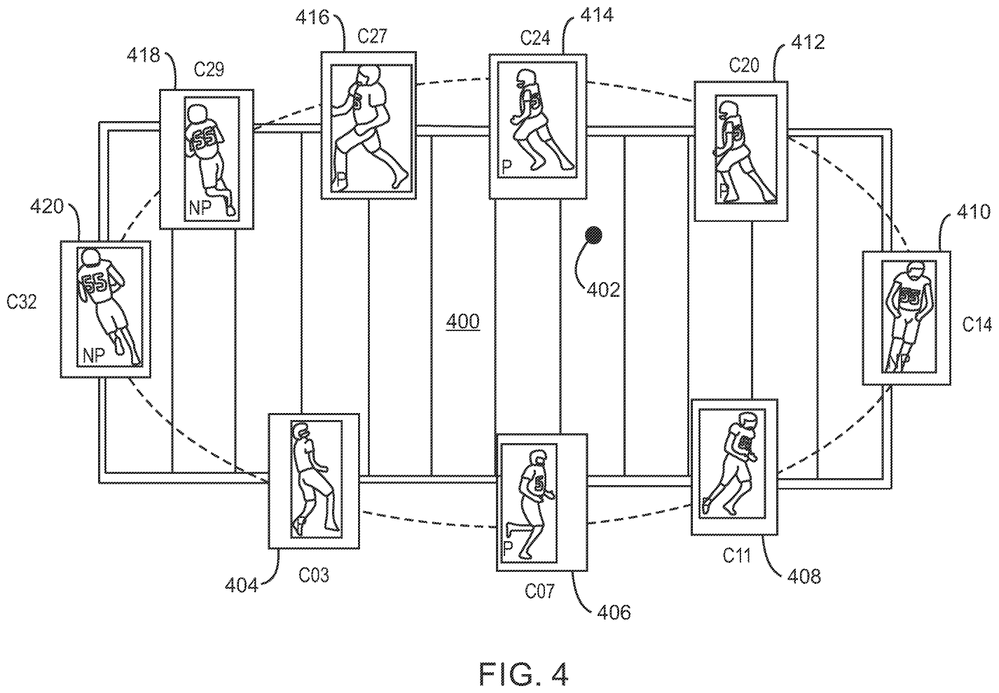

FIG. 4 is a plurality of cropped images captured by a camera system. As illustrated, a plurality of cameras C03, C07, C11, C14, C20, C24, C27, C29 and C32 surrounds the field of play 400. The cameras C03, C07, C11, C14, C20, C24, C27, C29 and C32 may be a as described with respect to FIG. 2. A player 402 may be located on the field of play 400. Each camera C03, C07, C11, C14, C20, C24, C27, C29 and, C32 captures a view of the player 402 at time t. As illustrated, camera C03 captures a view 404 of the player 402 at time t. Camera C07 captures a view 406 of the player 402 at time t. Camera C11 captures a view 408 of the player 402 at time t. Camera C14 captures a view 410 of the player 402 at time t. Camera C20 captures a view 412 of the player 402 at time t. Camera C24 captures a view 414 of the player 402 at time t. Camera C 27 captures a view 416 of the player 402 at time t. Camera C29 captures a view 418 of the player 402 at time t. Finally, camera C32 captures a view 420 of the player 402 at time t.

In embodiments, for each view, the entire field of play including multiple players is captured by each of the cameras. A person detection algorithm based on a you only look once (YOLO) is executed to detect all the players in field of play. An association of the bounding boxes of an identical player between frames in each camera view is found. Thus, bounding boxes identifying the player with jersey number 55 is found in each camera view as captured by cameras C03, C07, C11, C14, C20, C24, C27, C29 and, C32. For each camera view 404, 406, 408, 410, 412, 414, 416, 418, and 420 each detected player is assigned a unique track ID with respect to each camera. Each bounding box may be described by a location of the bounding box within the image according to xy coordinates. The width (w) and the height (h) of the bounding box is also given.

As illustrated in the example of FIG. 4, each camera view is cropped according to the bounding box for the player in each camera view. The captured player 402 has a different orientation with respect to each camera cameras C03, C07, C11, C14, C20, C24, C27, C29 and, C32 at time t. For each camera, an image is captured and a plurality of players is detected in each image. For each player of the plurality of players, a bounding box is defined during player detection. The bounding box may be defined by a location in the image frame as well as a width and a height of the bounding box. For each bounding box detected in an image frame, and orientation of the player within the bounding box is defined. In particular, according to the player orientation the player may be classified as a non-profile player or a profile player. In embodiments, the orientation of the player within the bounding box is defined according to a visibility of an identifier of the player within the bounding box. Accordingly, if an identifier of the player is substantially visible the player may be classified as a non-profile player. If an identifier of the player is not substantially visible, the player may be classified as a profile player.

In this manner, body orientation is used along with the position and size to describe a person/player. In FIG. 4, a same player is illustrated as a profile (P) and non-profile (NP) players with different orientation for each camera view. To output the orientation information, a classification module may be executed to output the player's orientation in the person detection network. Non-profile player images may then be transmitted to a jersey recognition module. In embodiments, the classification module may be the CNN network as implemented by a player detection module. In player detection, a player bounding box and the orientation info for the detected player is output. As illustrated in FIG. 4, a player (jersey number 55) can be detected and associated from multiple cameras. Each player bounding box has its orientation label. Only player image marked in “NP” can be used in the latter jersey number recognition module. Thus, the views 404, 406, 408, 412, 414, 416 will not be used since the player is oriented as a profile player. Instead, view 410, 418, and view 420 will be used for jersey number recognition as the player is oriented as a non-profile player. As a result of the processing as illustrated in the example of FIG. 4, an end user is able to view gameplay from any point within the field of play. The end user is also able to view a full 360° of the game at any point within the field of play. Thus, in embodiments and end user may experience gameplay from the perspective of any player.

The diagram of FIG. 4 is not intended to indicate that the example system is to include all of the cameras and views shown in FIG. 4. Rather, the example system can be implemented using fewer or additional cameras and views not illustrated in FIG. 4.

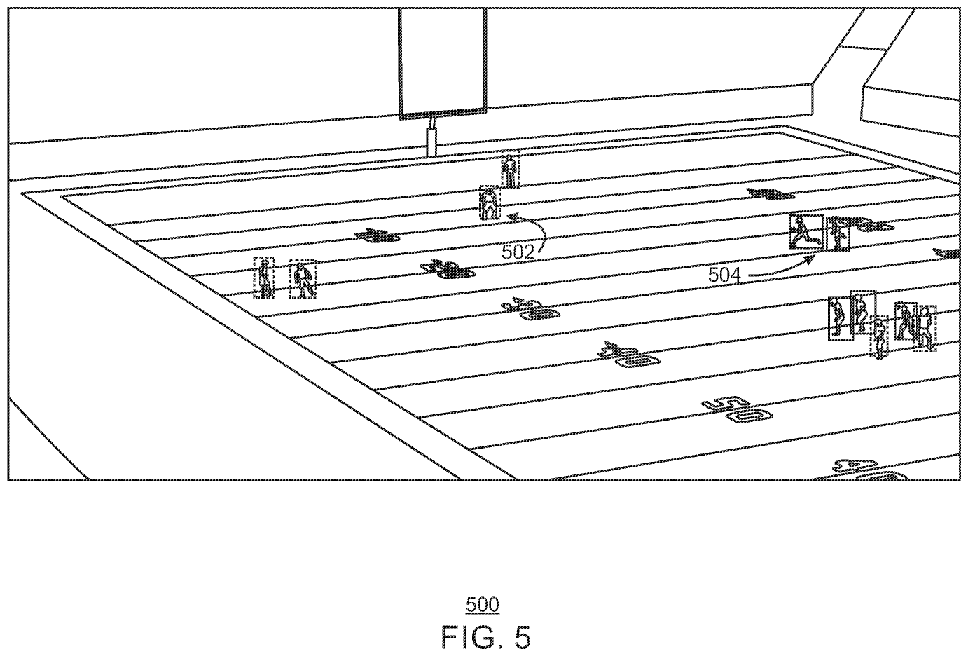

FIG. 5 is a single camera view 500. As an example, the camera view 500 may be captured by any one of the cameras of the camera system 202 (FIG. 2) or the cameras of FIG. 4. As illustrated in FIG. 5, a number of players are at various positions within the field of play captured in the camera view 500. In particular, players such as player 502 are classified as non-profile players. Players such as layer 504 are classified as profile players.

After obtaining player detection results for all cameras, jersey number recognition can be executed for all non-profile players. As illustrated in FIG. 5 for exemplary purposes, a dashed bounding box indicates that this player has a non-profile label and solid line bounding box represents a profile player. In the example camera view of FIG. 5, jersey number recognition is executed images of the non-profile players outlined using dashed bounding boxes.

The diagram of FIG. 5 is not intended to indicate that the example view 500 is to limited to the players, field, or cameras shown in FIG. 5. Rather, the example camera view can be of a field type not illustrated in FIG. 5. Further, the example camera view 500 can include additional or fewer players not illustrated in FIG. 5.

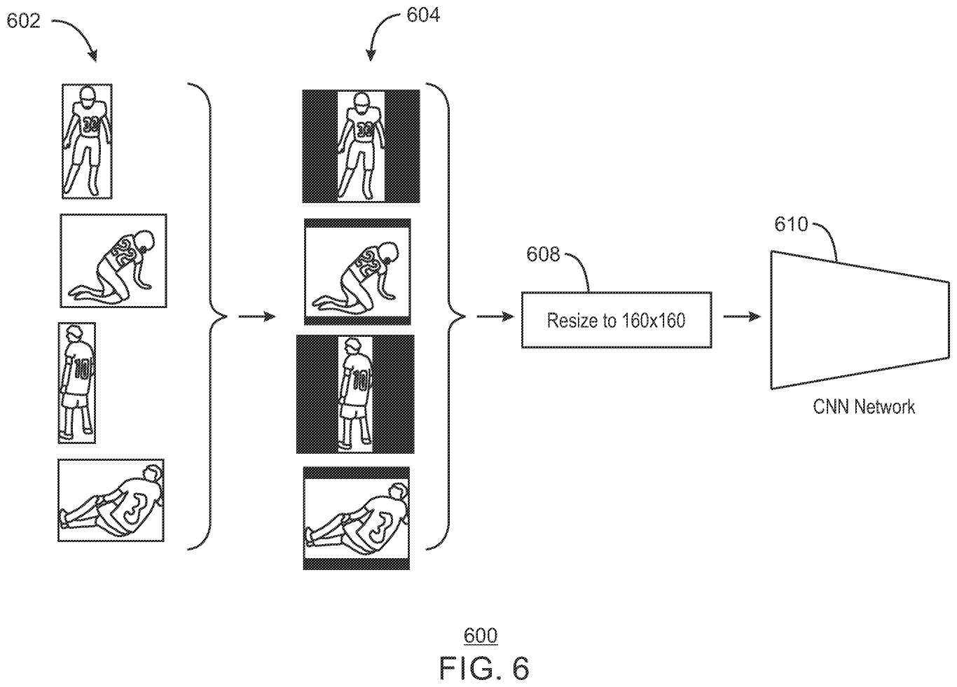

FIG. 6 is an illustration of a process 604 for padding the bounding box for each player. Typically, during game play some players appear larger than others within a particular camera view due to a location of the player on the field of play with respect to the camera. Accordingly, the bounding boxes associated with the players in a particular camera view may widely vary in size and shape. Additionally, as described below, precise jersey number location can substantially enhance jersey number recognition accuracy, unlike traditional image classification methods.

To determine a precise jersey number location, a convolutional neural network may be used. In particular, the present techniques enable an end to end detection and classification approach to jersey number recognition, where each number is assigned into a unique object category. For instance, in American football game, there are 99 possible jersey numbers, resulting in 99 classification categories ranging from 1˜99, and each category represents one unique number. Note that the jersey number is a player identifier. The present techniques may apply to other player identifiers with a greater or fewer number of possible classification categories.

In embodiments, in preparation for processing by the convolutional neural network, the bounding box for each detected player is padded to correspond to an input size of the CNN. The bounding boxes as obtained from the player detection results will likely vary in size and aspect ratio as player's body posture changes drastically during game play. By padding the bounding boxes, detection results are not resized. Put another way, the cropped image is not resized or resampled, nor is the resolution of the image changed. Instead, as illustrated in FIG. 6, a square template padding method is used to preserve an original aspect ratio of player detection boxes.

At block 602, each bounding box of a camera view is cropped according to the size of the player detection bounding box. In embodiments, the player image is cropped according to the player detection bounding box and then the max (height, width) of bounding box in this camera view is used as the square template length for this bounding box. Accordingly, the padding described herein uses a maximum height, width, or height and width of the bounding boxes for a current view as the square template length. At block 604, the bounding boxes/cropped images that are smaller than the template size are padded by placing the cropped image into the middle of the template and padding the remainder of the template with nonce values to achieve a same image size for each detected player. At block 608, each padded image is then resized for input into a convolutional neural network 610 for feature extraction. Directly resizing the cropped image will change the aspect ratio of the jersey. By padding the image as described herein, aspect ratio of jersey number remains the same, with no deformation. Accordingly, padding the image avoids deformation and significantly improves the jersey number recognition accuracy.

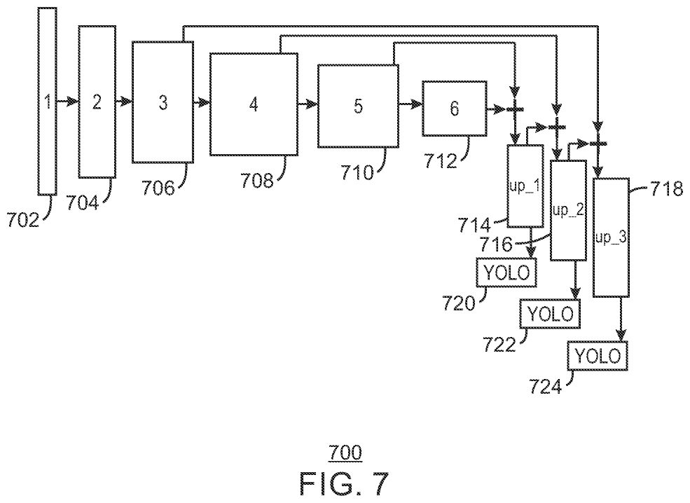

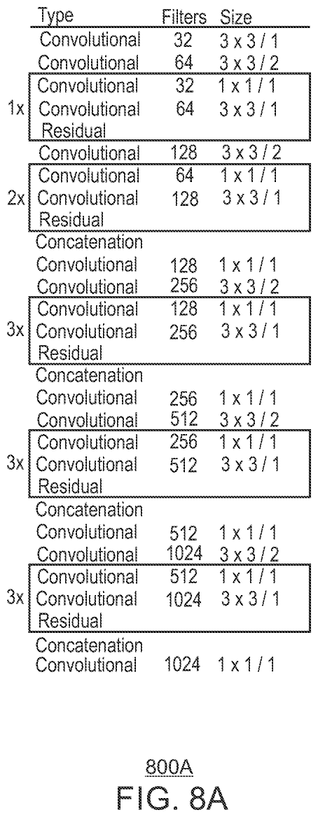

FIG. 7, FIG. 8A, and FIG. 8B illustrate a feature extraction network according to the present technique. In particular, FIG. 7 illustrates a neural network 700. The neural network 700 is executed to enable single camera player jersey number recognition. As discussed above, single camera jersey recognition is executed to recognize an identifier for each player detected in an image. The detected players may be identified using an orientation and a bounding box. Precisely locating the jersey number location plays a critical role to significantly improve the recognition accuracy.

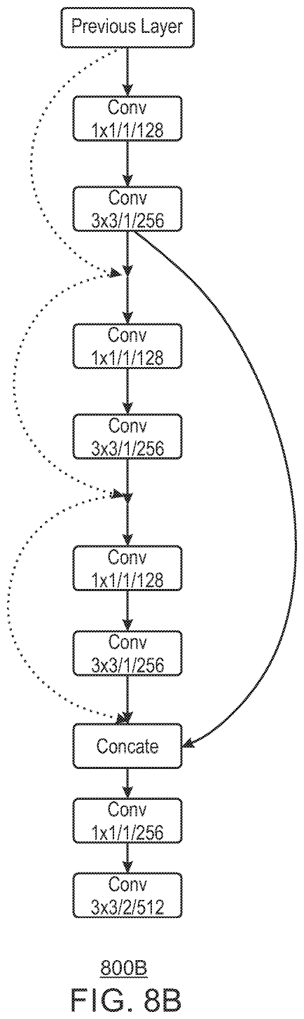

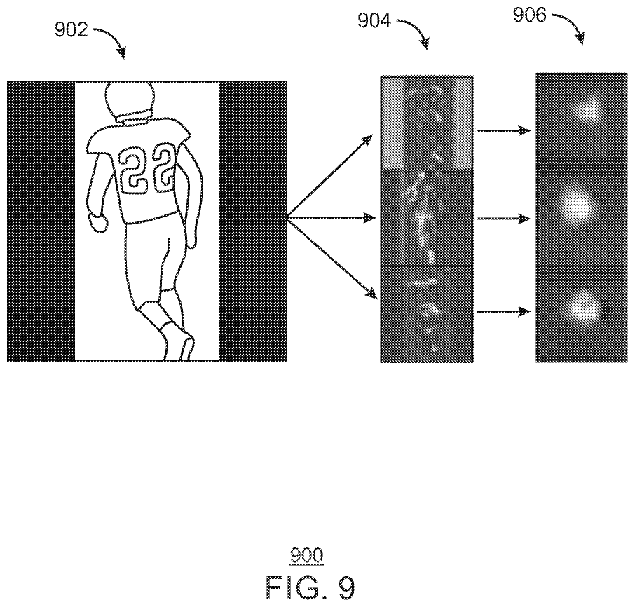

As illustrated in FIG. 7, a CNN feature extractor and classification network with a number of convolution blocks is used to extract features instead of using an off-of-shelf network. In particular, the neural network as described herein extracts semantic features of jersey numbers from the input player image. The overall structure of the deep CNN network is feature pyramid network which is composed of six down-sample convolution blocks 702, 704, 706, 708, 710, and 712 and three up-sample convolution blocks 714, 716, and 718. It produces three multi-scale features including the high-resolution low-level features and higher-level semantics low-resolution features. Every block consists of 3×3 and 1×1 convolution layers and each convolution layer is followed by a batch normalization and RELU activation. Five 3×3 stride 2 convolution layers are used as down-sample layer at the last layer of down-sample blocks 702, 704, 706, 708, and 710. To save or reduce computation costs, in embodiments 160×160 is used as the input size, rather than input sizes of 224×224 or 300×300. However, any input size may be used according to the present techniques. Additionally, YOLO detection is applied to the three multi-scale features including the high-resolution low-level features and higher-level semantic low-resolution features to obtain a jersey number for each player within a bounding box. These features are illustrated with respect to FIG. 9, where high-resolution low-level features (edge, lines, can basically see the contour of object) are illustrated at reference number 904 and a sample of higher-level semantic low-resolution features are illustrated at reference number 906. In order to keep rich feature representation with minimal computational cost, the proposed light-weighted network only uses 34 convolution layers compared with 53 convolution layers of conventional techniques.

FIG. 8A describes the layers of the CNN as implemented according to the present techniques. In particular, FIG. 8A describes the type, filters, and size of the convolution layers of the feature extraction network. Specifically, the details of the feature extraction network with a series combination of 1×1 and 3×3 stride-1 convolutional kernel are illustrated. FIG. 8B is an illustration of down-sample block 4 from the CNN of the feature extraction network. This down-sample block 4 is illustrated at reference number 708 in FIG. 7. As shown in FIG. 7, a light-weight but powerful CNN feature extraction network is executed to extract semantic features of jersey numbers from the input player image. The overall structure of the convolutional neural network is a feature pyramid network which composes of six down-sample convolution blocks and three up-sample convolution blocks.

FIG. 8B illustrates a shortcut for use in the down sample blocks 702, 704, 706, 708, 710, and 712 of FIG. 7. This short cut is represented by the dotted lines in FIG. 8B. The shortcut represents shortcut connections within the CNN, and are obtained from a residual network. In FIG. 8B, the concatenation is represented by solid lines. The concatenation in FIG. 8B merges the output of the first 3×3 convolution layer with the input of last 3×3 convolution layer. In this manner, feature extraction network produces three multi-scale features including the high-resolution low-level features and higher-level semantic low-resolution features.

FIG. 9 is an illustration of feature extraction. At block 902, a cropped image is input to the feature extraction network. Low-level features are illustrated at block 904. The low-level features may be, for example, edges, lines, and other image features that make up the contour of the object. High-level features are illustrated at block 906. In FIG. 9, low-level features and higher-level features are processed by different convolution layers. Low-level features have a high-resolution but weaker semantic information, and higher-level features have low-resolution but higher semantic information. In order to exploit the semantic information in both low-level and higher-level features, the network as illustrated in FIG. 7 adds several concatenation layers in the down-sample blocks 702, 704, 706, 708, 710, and 712. For example, in the down-sample block 4 708 (FIG. 7), the concatenation layer merges the output of the first 3×3 convolution layer with the input of last 3×3 convolution layer as depicted in the solid line in FIG. 8B.

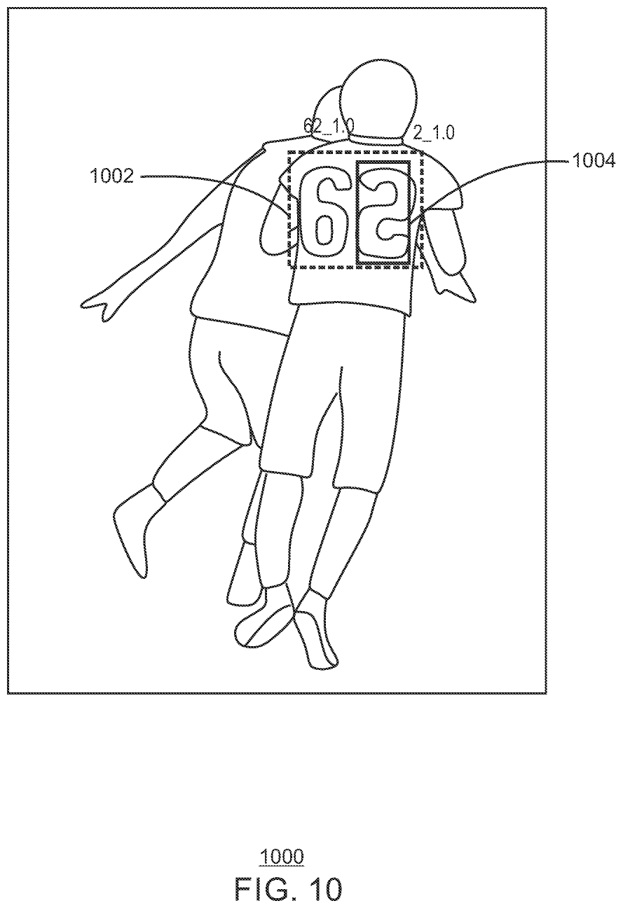

FIG. 10 is an illustration of feature/extraction matching results after hard non-maximum suppression (NMS). In NMS, a bounding box with the maximum detection confidence score is selected and its neighboring boxes are suppressed using a pre-defined overlap threshold. Accordingly, NMS starts with a list of detection results “b.” The detection results are sorted by a confidence score of every bounding box, and every b in B is arranged from high confidence to low confidence. Then, the bounding box with the maximum score is selected. The score is set to 0 if any box which has the same label and overlap has a threshold greater than Nt, where Nt is an overlap threshold of non-maximum suppression. This process is repeated for all boxes in B, from high confidence to low confidence.

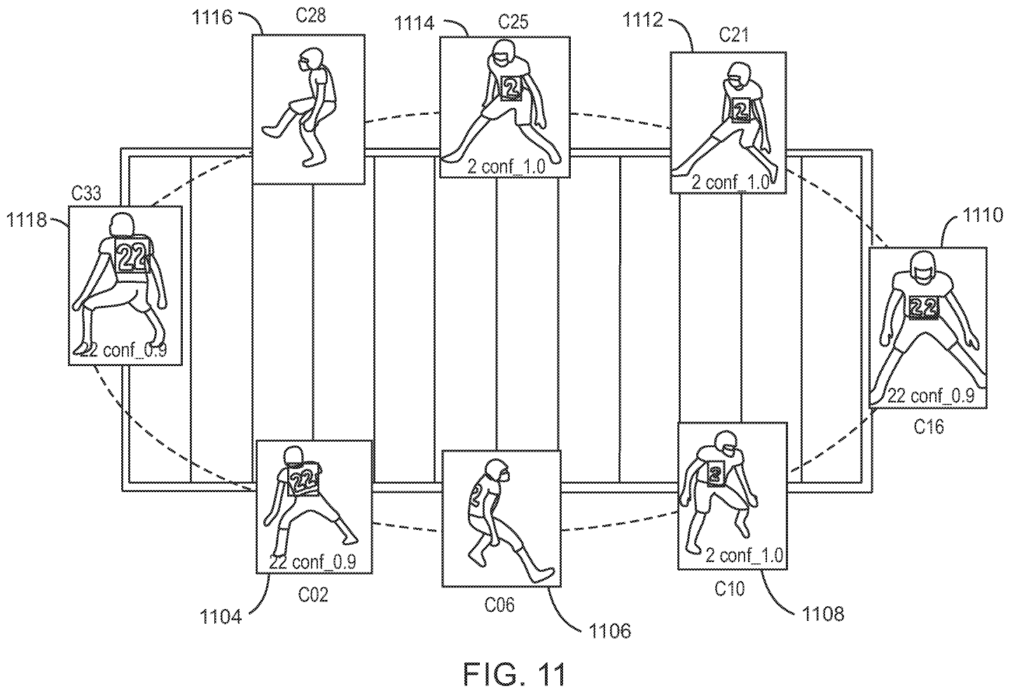

For jersey number recognition, there are normally two types of jersey number, i.e., single digit and double-digit numbers. A double-digit number is a combination of two single digits. If the double-digit jersey number has location overlap with single digit number, it is very likely that the single digit number is part of the double-digit number. FIG. 11 is an illustration of jersey number recognition results with two outputs. Specifically, the jersey numbers that are recognized are 62 and 2. As illustrated, 62 is the correct jersey number.

Hard-NMS may be implemented according to the present techniques. Firstly, a hard-sort is executed instead of traditional sort which only depends on the scores of bounding boxes. The hard sort depends on both the scores and the bounding box location/size. In the hard sort, the bounding boxes are sorted based on the rectangle size (height*width). If two bounding boxes have the same score, the bigger size bounding box is likely correct when the scores are equivalent. Then, an intersection over union (IOU) is computed for all labels of bounding boxes. This assumes that that one player image only contains one unique jersey number. In addition, the IOU may be modified. In particular, conventional IOU (bᵢ, bⱼ) means an overlap area of bᵢ and bⱼ divided by union area bᵢ and bⱼ. The IOU according to the present techniques yields a hard IOU (bᵢ, bⱼ), with an overlap area of bᵢ and bⱼ divided by area of bⱼ. The IOU according to the present techniques improves sensitivity of the hard NMS to bounding box intersection.

For example, the algorithm below describes hard-non maximum suppression according to the present techniques.

As illustrated in FIG. 11, though we use non-profile player for jersey recognition, there are failures cases. As illustrated, a camera C02 captures a view 1104 of the player 1102. A camera C06 captures a view 1106 of the player 1102. A camera C10 captures a view 1108 of the player 1102. A camera C16 captures a view 1110 of the player 1102. A camera C21 captures a view 1112 of the player 1102. A camera C25 captures a view 1114 of the player 1102. A camera C28 captures a view 1116 of the player 1102. Finally, a camera C33 captures a view 1120 of the player 1102.

Jersey numbers of some players may be erroneously recognized as a single digit number due to partial jersey number visibility. After getting all players' bounding boxes and jersey number, correspondences may be found from the same player from different cameras through multiple camera association. Then, a single view jersey number recognition may be applied to the non-profile players in each frame. This results in an initial multiple camera jersey number of the player and count frequency of occurrence for this player jersey number results. In particular, cumulative voting may be used to determine a final jersey number.

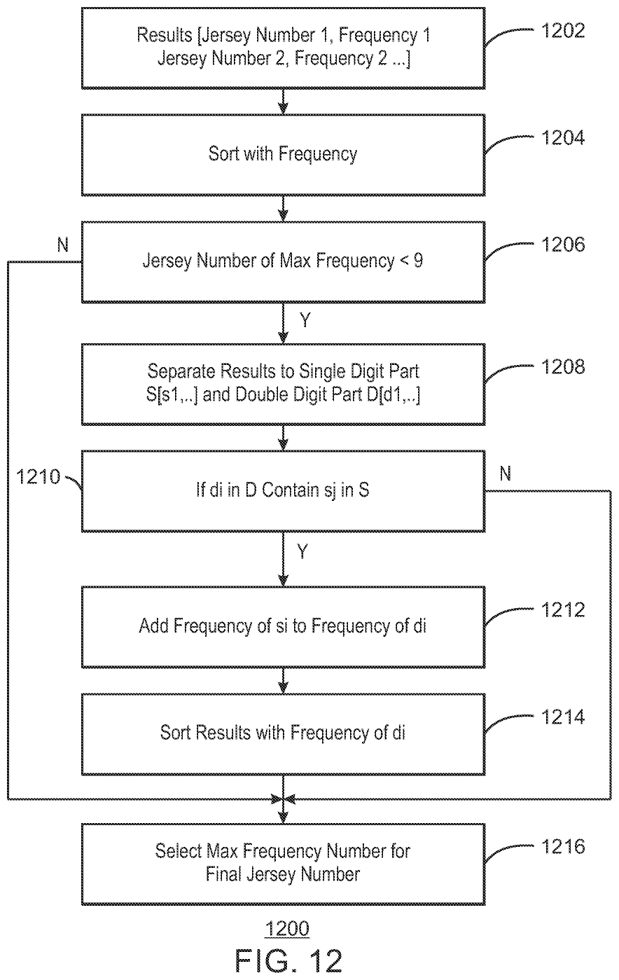

FIG. 12 is a process flow diagram illustrating a method 1200 for cumulative voting. To handle jersey number result ambiguity, a voting policy is implemented to improve the recognition accuracy. The voting policy equally considers the output from each camera, where a single digit number will also vote for double digit number if it is part of the double-digit number. As illustrated in FIG. 12, after all jersey number results for one player including occurrence frequency are obtained, the frequency of the single digit occurrences is added to the double-digits jersey number occurrences if double digit number contains this single digit number. Finally, the results are sorted again according to the frequency. The result with highest frequency is the final selected jersey number.

Accordingly, at block 1202 for each player detection results are obtained. The detection results include each jersey number associated with the player as well as a frequency that each jersey number was detected. As described above, each player can be located across camera views via a player detection module. At block 1204, each candidate jersey number is sorted according to frequency.

For each candidate jersey number, at block 1206 it is determined if frequency of the candidate jersey number is a less than nine. The number nine is selected here for exemplary purposes only. The number selected at block 1206 can be according to a certain percentage of cameras or any other subset of cameras. If the candidate jersey number has a maximum frequency that is less than nine, process flow continues to block 1208. If the candidate jersey number has a maximum frequency that is greater than nine process flow continues to block 1216.

At block 1208, processing begins for the candidate jersey number results with frequencies that are greater than nine. In particular, in response to the candidate jersey number being a double digit, the candidate jersey number is separated into a single digit part and a double-digit part. At block 1210 it is determined if the double-digit part contains the single digit part of the candidate jersey number. If the double-digit part contains the single digit part of the candidate jersey number, process flow continues to block 1212. If the double-digit part does not contain the single digit part of the candidate jersey number process flow proceeds to block 1216.

At block 1212, the frequency of the single digit part of the candidate jersey number is added to the frequency of the double-digit part of the candidate jersey number. At block 1214, the jersey number results are again sorted according to frequency. At block 1216 the candidate jersey number with the maximum frequency is selected as the final jersey number.

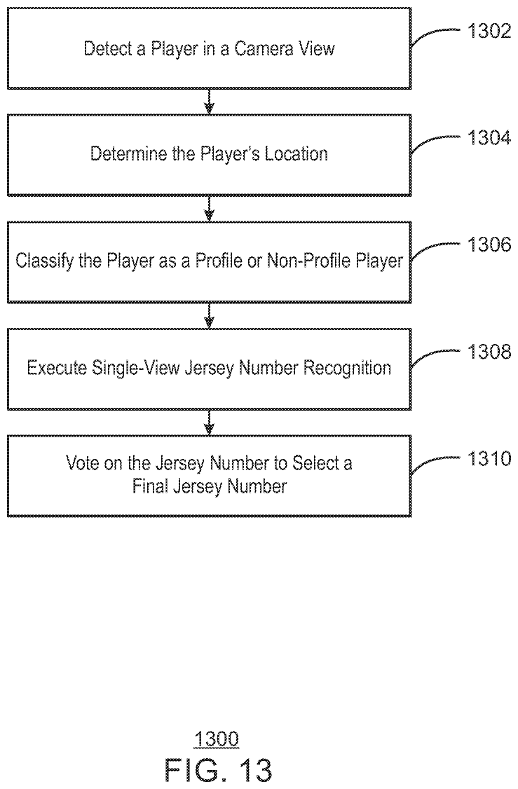

FIG. 13 is a process flow diagram of a method 1300 that enables multiple camera jersey recognition. At block 1302, a player is detected in a view from a single camera. In embodiments, the system includes multiple cameras wherein players are detected in each camera view. In embodiments, a player detection module may be executed to detect a player in each camera view. As described above, the player may be detected in the camera view and a bounding box may be generated. The bounding box may be a bounding area that includes/surrounds the detected player.

At block 1304, for each detected player player's location is determined. In embodiments, the location of the player may be a point within the captured 3D volume. In order to determine the location of the players within the 3D volume, the location of the player as captured by each camera at a time T is processed to derive the player location.

At block 1306, each player is classified as a non-profile player or a profile player. In embodiments, the player may be classified based on an orientation of the player with respect to the image plane of the camera. Additionally, in embodiments, the player may be classified as a profile or a non-profile player based on visibility of an identifier worn on the player. As described her in, the identifier is a jersey number. At block 1308, single view jersey number recognition is executed. The single view jersey number recognition takes as input a bounding box of the player in a camera image/frame/view, and an orientation of the player. Based on the input, the single view jersey number recognition extracts a plurality of features from the image of the player and determines a candidate jersey number for each camera view. At block 1310, the candidate jersey numbers are subjected to a cumulative voting process to determine a final jersey number. The cumulative voting process may be the process as described with regard to FIG. 12.

The diagram of FIG. 13 is not intended to indicate that the example method 1300 is to include all of the blocks shown in FIG. 13. Rather, the method 1300 can be implemented using fewer or additional blocks not illustrated in FIG. 13.

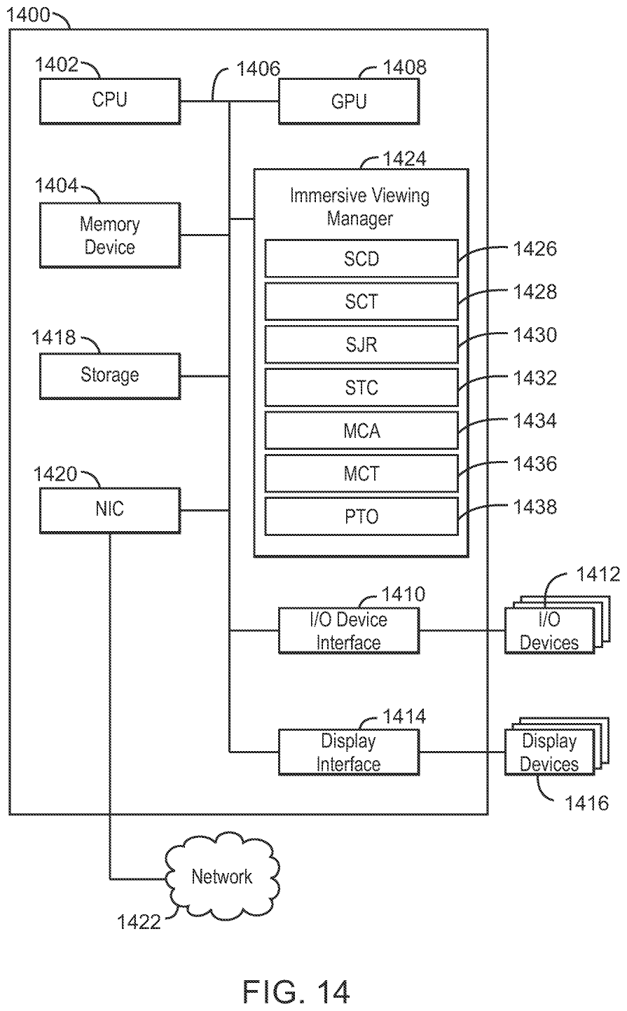

Referring now to FIG. 14, a block diagram is shown illustrating the generation of an immersive media experience. The computing device 1400 may be, for example, a laptop computer, desktop computer, tablet computer, mobile device, or wearable device, among others. In some examples, the computing device 1400 may be a smart camera or a digital security surveillance camera. The computing device 1400 may include a central processing unit (CPU) 1402 that is configured to execute stored instructions, as well as a memory device 1404 that stores instructions that are executable by the CPU 1402. The CPU 1402 may be coupled to the memory device 1404 by a bus 1406. Additionally, the CPU 1402 can be a single core processor, a multi-core processor, a computing cluster, or any number of other configurations. Furthermore, the computing device 1400 may include more than one CPU 1402. In some examples, the CPU 1402 may be a system-on-chip (SoC) with a multi-core processor architecture. In some examples, the CPU 1402 can be a specialized digital signal processor (DSP) used for image processing. The memory device 1404 can include random access memory (RAM), read only memory (ROM), flash memory, or any other suitable memory systems. For example, the memory device 1404 may include dynamic random-access memory (DRAM).

The computing device 1400 may also include a graphics processing unit (GPU) 1408. As shown, the CPU 1402 may be coupled through the bus 1406 to the GPU 1408. The GPU 1408 may be configured to perform any number of graphics operations within the computing device 1400. For example, the GPU 1408 may be configured to render or manipulate graphics images, graphics frames, videos, or the like, to be displayed to a viewer of the computing device 1400.

The CPU 1402 may also be connected through the bus 1406 to an input/output (I/O) device interface 1410 configured to connect the computing device 1400 to one or more I/O devices 1412. The I/O devices 1412 may include, for example, a keyboard and a pointing device, wherein the pointing device may include a touchpad or a touchscreen, among others. The I/O devices 1412 may be built-in components of the computing device 1400, or may be devices that are externally connected to the computing device 1400. In some examples, the memory 1404 may be communicatively coupled to I/O devices 1412 through direct memory access (DMA).

The CPU 1402 may also be linked through the bus 1406 to a display interface 1414 configured to connect the computing device 1400 to a display device 1416. The display devices 1416 may include a display screen that is a built-in component of the computing device 1400. The display devices 1416 may also include a computer monitor, television, or projector, among others, that is internal to or externally connected to the computing device 1400. The display device 1416 may also include a head mounted display.

The computing device 1400 also includes a storage device 1418. The storage device 1418 is a physical memory such as a hard drive, an optical drive, a thumbdrive, an array of drives, a solid-state drive, or any combinations thereof. The storage device 1418 may also include remote storage drives.

The computing device 1400 may also include a network interface controller (NIC) 1420. The NIC 1420 may be configured to connect the computing device 1400 through the bus 1406 to a network 1422. The network 1422 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

The computing device 1400 further includes an immersive viewing manager 1424. The immersive viewing manager 1424 may be configured to enable a 360° view of a sporting event from any angle. In particular images captured by a plurality of cameras may be processed such that an end user can virtually experience any location within the field of play. In particular, the end user may establish a viewpoint in the game, regardless of particular camera locations used to capture images of the sporting event. The immersive viewing manager 1424 includes an SCD module 1426 to determine isolated bounding boxes of each player in each captured camera view. An SCT module 1428 is to obtain the association of the bounding boxes of an identical player between frames in each camera view, assigning identical players a unique track ID between different frames.

An SJR module 1430 is to recognize the jersey number of a player. In embodiments, the jersey number is recognized for each player in real-time. The single use jersey number recognition as described herein includes pre-processing, feature extraction, feature matching, and non-maximum suppression. A single view jersey number recognition process takes as input the detected profile player images as defined by a bounding box. Features are extracted from the detected non-profile player images. A you only look once (YOLO) regression is applied to the extracted features. Finally, a hard NMS algorithm is applied to the features to obtain jersey number results.

An STC module 1432 is to recognize the team tag of a player. An MCA module 1434 uses bounding boxes of a player in one frame from each camera view to derive a 2D/3D location pf the player in the field of play. An MCT module 1436 derives correspondences and connects the temporal and spatial associations to determine a global player identification of each player in the field of play. Finally, a PTO module 1438 takes as input the jersey/team information and locations and generates player trajectories.

The block diagram of FIG. 14 is not intended to indicate that the computing device 1400 is to include all of the components shown in FIG. 14. Rather, the computing device 1400 can include fewer or additional components not illustrated in FIG. 14, such as additional buffers, additional processors, and the like. The computing device 1400 may include any number of additional components not shown in FIG. 14, depending on the details of the specific implementation. Furthermore, any of the functionalities of the immersive viewing manager 1424, SCD module 1426, SCT module 1428, SJR module 1430, STC module 1432, MCA module 1434, MCT module 1436, and PTO module 1438 may be partially, or entirely, implemented in hardware and/or in the processor 1402. For example, the functionality may be implemented with an application specific integrated circuit, in logic implemented in the processor 1402, or in any other device. For example, the functionality of the immersive viewing manager 1424 may be implemented with an application specific integrated circuit, in logic implemented in a processor, in logic implemented in a specialized graphics processing unit such as the GPU 1408, or in any other device.

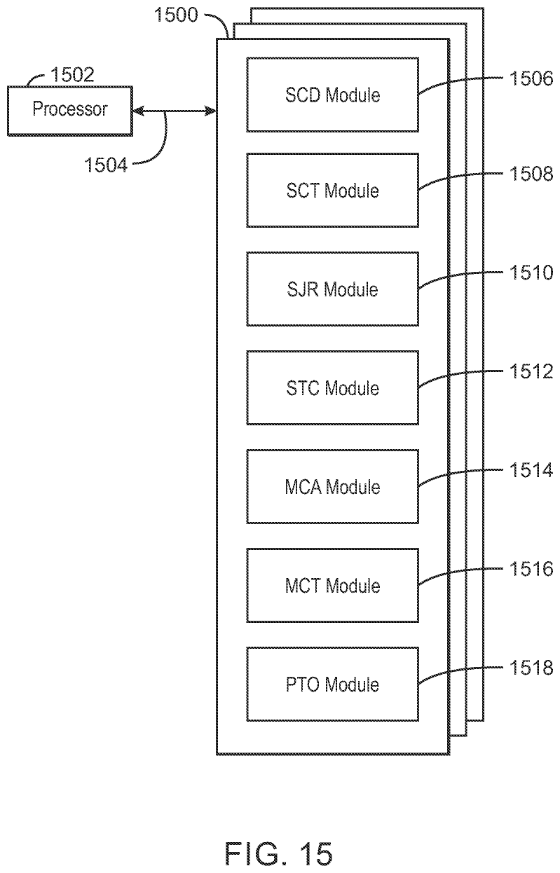

FIG. 15 is a block diagram showing computer readable media 1500 that stores code the generation of an immersive media experience. The computer readable media 1500 may be accessed by a processor 1502 over a computer bus 1504. Furthermore, the computer readable medium 1500 may include code configured to direct the processor 1502 to perform the methods described herein. In some embodiments, the computer readable media 1500 may be non-transitory computer readable media. In some examples, the computer readable media 1500 may be storage media.

The various software components discussed herein may be stored on one or more computer readable media 1500, as indicated in FIG. 15. For example, an SCD module 1506 is to determine isolated bounding boxes of each player in each captured camera view. An SCT module 1508 is to obtain the association of the bounding boxes of an identical player between frames in each camera view, assigning identical players a unique track ID between different frames.

An SJR module 1510 is to recognize the jersey number of a player. The single use jersey number recognition as described herein includes pre-processing, feature extraction, feature matching, and non-maximum suppression. A single view jersey number recognition process takes as input the detected profile player images as defined by a bounding box. Features are extracted from the detected non-profile player images. A you only look once (YOLO) regression is applied to the extracted features. Finally, a hard NMS algorithm is applied to the features to obtain jersey number results.

An STC module 1512 is to recognize the team tag of a player. An MCA module 1514 uses bounding boxes of a player in one frame from each camera view to derive a 2D/3D location pf the player in the field of play. An MCT module 1516 derives correspondences and connects the temporal and spatial associations to determine a global player identification of each player in the field of play. Finally, a PTO module 1518 takes as input the jersey/team information and locations and generates player trajectories.

The block diagram of FIG. 15 is not intended to indicate that the computer readable media 1500 is to include all of the components shown in FIG. 15. Further, the computer readable media 1500 may include any number of additional components not shown in FIG. 15, depending on the details of the specific implementation.

### EXAMPLES

Example 1 is a method. The method includes detecting a player in a camera view captured by a camera; determining a player location of the player in each camera view, wherein the player location is defined by a bounding box; classifying the player as a profile player or a non-profile player based on a visibility of an identifier; in response to the player being a non-profile player: extracting features from the detected player within the bounding box; classifying a plurality of labels according to the extracted features; and selecting a label from the plurality of labels with a highest number of votes according to a voting policy as a final label.

Example 2 includes the method of example 1, including or excluding optional features. In this example, the method includes applying hard non-maximum suppression to the extracted features to obtain bounding boxes with the plurality of labels to be classified.

Example 3 includes the method of any one of examples 1 to 2, including or excluding optional features. In this example, the identifier is a jersey number worn by the player during game play.

Example 4 includes the method of any one of examples 1 to 3, including or excluding optional features. In this example, the classification of the player as a profile player or a non-profile player indicates the orientation of the player with respect to an image plane of the camera.

Example 5 includes the method of any one of examples 1 to 4, including or excluding optional features. In this example, the identifier of a non-profile player is substantially visible wherein the camera view of the identifier is used to derive the entire identifier.

Example 6 includes the method of any one of examples 1 to 5, including or excluding optional features. In this example, the identifier of each profile player is not substantially visible, wherein the camera view of the identifier cannot be used to derive the entire identifier.

Example 7 includes the method of any one of examples 1 to 6, including or excluding optional features. In this example, in response to the player being classified as a profile player, not using the camera view for jersey number recognition.

Example 8 includes the method of any one of examples 1 to 7, including or excluding optional features. In this example, in preparation for processing the extracted features by a convolutional neural network (CNN), the bounding box for the player is padded to correspond to an input size of the CNN.

Example 9 includes the method of any one of examples 1 to 8, including or excluding optional features. In this example, extracting features from the detected player within the bounding box precisely locates a candidate identifier.

Example 10 includes the method of any one of examples 1 to 9, including or excluding optional features. In this example, extracting features from the detected player within the bounding box extracts high-resolution low-level features and higher-level semantic low-resolution features.

Example 11 is a system. The system includes a processor to: detect a player in a camera view captured by a camera; determine a player location of the player in each camera view, wherein the player location is defined by a bounding box; classify the player as a profile player or a non-profile player based on a visibility of an identifier; and in response to the player being a non-profile player: extract features from the detected player within the bounding box; classify the features according to a label; and select a label with a highest number of votes according to a voting policy as a final label.

Example 12 includes the system of example 11, including or excluding optional features. In this example, the identifier is a jersey number worn by the player during game play.

Example 13 includes the system of any one of examples 11 to 12, including or excluding optional features. In this example, the classification of the player as a profile player or a non-profile player indicates the orientation of the player with respect to an image plane of the camera.

Example 14 includes the system of any one of examples 11 to 13, including or excluding optional features. In this example, the identifier of a non-profile player is substantially visible wherein the camera view of the identifier is used to derive the entire identifier.

Example 15 includes the system of any one of examples 11 to 14, including or excluding optional features. In this example, the identifier of each profile player is not substantially visible, wherein the camera view of the identifier cannot be used to derive the entire identifier.

Example 16 includes the system of any one of examples 11 to 15, including or excluding optional features. In this example, in response to the player being classified as a profile player, not using the camera view for jersey number recognition.

Example 17 includes the system of any one of examples 11 to 16, including or excluding optional features. In this example, in preparation for processing the extracted features by a convolutional neural network (CNN), the bounding box for the player is padded to correspond to an input size of the CNN.

Example 18 includes the system of any one of examples 11 to 17, including or excluding optional features. In this example, extracting features from the detected player within the bounding box precisely locates a candidate identifier.

Example 19 includes the system of any one of examples 11 to 18, including or excluding optional features. In this example, extracting features from the detected player within the bounding box extracts high-resolution low-level features and higher-level semantic low-resolution features.

Example 20 includes the system of any one of examples 11 to 19, including or excluding optional features. In this example, hard non-maximum suppression is applied to the extracted features.

Example 21 is at least one non-transitory computer-readable medium. The computer-readable medium includes instructions that direct the processor to detect a player in a camera view captured by a camera; determine a player location of the player in each camera view, wherein the player location is defined by a bounding box; classify the player as a profile player or a non-profile player based on a visibility of an identifier; in response to the player being a non-profile player: extract features from the detected player within the bounding box; classify a plurality of labels according to the extracted features; and select a label from the plurality of labels with a highest number of votes according to a voting policy as a final label.

Example 22 includes the computer-readable medium of example 21, including or excluding optional features. In this example, the computer-readable medium includes applying hard non-maximum suppression to the extracted features to obtain bounding boxes with the plurality of labels to be classified.

Example 23 includes the computer-readable medium of any one of examples 21 to 22, including or excluding optional features. In this example, the identifier is a jersey number worn by the player during game play.

Example 24 includes the computer-readable medium of any one of examples 21 to 23, including or excluding optional features. In this example, the classification of the player as a profile player or a non-profile player indicates the orientation of the player with respect to an image plane of the camera.

Example 25 includes the computer-readable medium of any one of examples 21 to 24, including or excluding optional features. In this example, the identifier of a non-profile player is substantially visible wherein the camera view of the identifier is used to derive the entire identifier.

Not all components, features, structures, characteristics, etc. described and illustrated herein need be included in a particular aspect or aspects. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some aspects have been described in reference to particular implementations, other implementations are possible according to some aspects. Additionally, the arrangement and/or order of circuit elements or other features illustrated in the drawings and/or described herein need not be arranged in the particular way illustrated and described. Many other arrangements are possible according to some aspects.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more aspects. For instance, all optional features of the computing device described above may also be implemented with respect to either of the methods or the computer-readable medium described herein. Furthermore, although flow diagrams and/or state diagrams may have been used herein to describe aspects, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A method, comprising:
detecting a player in a camera view captured by a camera;
determining a player location of the player in each camera view, wherein the player location is defined by a bounding box;
classifying the player as a profile player or a non-profile player based on a visibility of an identifier;
in response to the player being a non-profile player:
extracting features from the detected player within the bounding box;
classifying a plurality of labels according to the extracted features; and
selecting a label from the plurality of labels with a highest number of votes according to a voting policy as a final label.

2. The method of claim 1, comprising applying hard non-maximum suppression to the extracted features to obtain bounding boxes with the plurality of labels to be classified.

3. The method of claim 1, wherein the identifier is a jersey number worn by the player during game play.

4. The method of claim 1, wherein the classification of the player as a profile player or a non-profile player indicates the orientation of the player with respect to an image plane of the camera.

5. The method of claim 1, wherein the identifier of a non-profile player is substantially visible wherein the camera view of the identifier is used to derive the entire identifier.

6. The method of claim 1, wherein the identifier of each profile player is not substantially visible, wherein the camera view of the identifier cannot be used to derive the entire identifier.

7. The method of claim 1, wherein in response to the player being classified as a profile player, not using the camera view for jersey number recognition.

8. The method of claim 1, wherein in preparation for processing the extracted features by a convolutional neural network (CNN), the bounding box for the player is padded to correspond to an input size of the CNN.

9. The method of claim 1, wherein extracting features from the detected player within the bounding box precisely locates a candidate identifier.

10. The method of claim 1, wherein extracting features from the detected player within the bounding box extracts high-resolution low-level features and higher-level semantic low-resolution features.

11. A system, comprising:
a processor to:
detect a player in a camera view captured by a camera;
determine a player location of the player in each camera view, wherein the player location is defined by a bounding box;
classify the player as a profile player or a non-profile player based on a visibility of an identifier; and
in response to the player being a non-profile player:
extract features from the detected player within the bounding box;
classify the features according to a label; and
select a label with a highest number of votes according to a voting policy as a final label.

12. The system of claim 11, wherein the identifier is a jersey number worn by the player during game play.

13. The system of claim 11, wherein the classification of the player as a profile player or a non-profile player indicates the orientation of the player with respect to an image plane of the camera.

14. The system of claim 11, wherein the identifier of a non-profile player is substantially visible wherein the camera view of the identifier is used to derive the entire identifier.

15. The system of claim 11, wherein the identifier of each profile player is not substantially visible, wherein the camera view of the identifier cannot be used to derive the entire identifier.

16. The system of claim 11, wherein in response to the player being classified as a profile player, not using the camera view for jersey number recognition.

17. The system of claim 11, wherein in preparation for processing the extracted features by a convolutional neural network (CNN), the bounding box for the player is padded to correspond to an input size of the CNN.

18. The system of claim 11, wherein extracting features from the detected player within the bounding box precisely locates a candidate identifier.

19. The system of claim 11, wherein extracting features from the detected player within the bounding box extracts high-resolution low-level features and higher-level semantic low-resolution features.

20. The system of claim 11, wherein hard non-maximum suppression is applied to the extracted features.

21. At least one non-transitory computer-readable medium, comprising instructions to direct a processor to:
detect a player in a camera view captured by a camera;
determine a player location of the player in each camera view, wherein the player location is defined by a bounding box;
classify the player as a profile player or a non-profile player based on a visibility of an identifier;
in response to the player being a non-profile player:
extract features from the detected player within the bounding box;
classify a plurality of labels according to the extracted features; and
select a label from the plurality of labels with a highest number of votes according to a voting policy as a final label.

22. The computer readable medium of claim 21, comprising applying hard non-maximum suppression to the extracted features to obtain bounding boxes with the plurality of labels to be classified.

23. The computer readable medium of claim 21, wherein the identifier is a jersey number worn by the player during game play.

24. The computer readable medium of claim 21, wherein the classification of the player as a profile player or a non-profile player indicates the orientation of the player with respect to an image plane of the camera.

25. The computer readable medium of claim 21, wherein the identifier of a non-profile player is substantially visible wherein the camera view of the identifier is used to derive the entire identifier.
